(19) United States
(12) Patent Application Publication
(10) Pub. No.: US 2025/0315455 A1
(43) Pub. Date: Oct. 9, 2025

(54) LOCATION MAPPING USING TIDAL DATA AND OTHER CATEGORICAL GEOGRAPHIC DATA

(71) Applicant: Apple Inc., Cupertino, CA (US)

(72) Inventors: Jared K. McGann, San Jose, CA (US); Joseph J. Dion, San Jose, CA (US); Vincent T. Frisina, Sparta, NJ (US); Vinod Mohanan, North Andover, MA (US)

(73) Assignee: Apple Inc., Cupertino, CA (US)

(21) Appl. No.: 19/082,582

(22) Filed: Mar. 18, 2025

Related U.S. Application Data
(60) Provisional application No. 63/631,383, filed on Apr. 8, 2024.

(51) Int. Cl. G06F 16/29; G06F 16/2457

(52) U.S. Cl. CPC G06F 16/29; G06F 16/2457

(57) ABSTRACT

The present disclosure generally relates to location mapping. More specifically, techniques are described for correlating, or associating multiple specialized databases (e.g., map database, tides database, etc.) to provide useful information and display on a mobile device. In some embodiments, the disclosed techniques can identify, for a mobile device, nearby map locations containing particular category of meteorological or terrain information by performing a spatial search on a category-specific geographic database, and using the searched result to further search a geographical name database. In some embodiments, the disclosed techniques can add a new map location containing particular category of meteorological or terrain information by performing a category search of a geographical name database, and using the searched result to perform a spatial search of the category-specific geographic database.

CROSS-REFERENCES TO OTHER APPLICATIONS

This application claims priority to U.S. Provisional Application No. 63/631,383, for “LOCATION MAPPING USING TIDAL DATA AND OTHER CATEGORICAL GEOGRAPHIC DATA” filed on Apr. 8, 2024, which is herein incorporated by reference in its entirety for all purposes.

### BACKGROUND

Maps help people travel, explore new places, and plan activities. Map-related applications have gained popularity with the prevalence of mobile devices. However, certain categories of locations are not readily available on a map. It is desirable to provide category-specific geographic information for mobile device users who are interested in such category-specific locations, such as users specializing in certain activities (e.g., surfing or skiing).

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect includes a method performed by one or more processors of a mobile device. The method also includes receiving a search request for information related to a particular category of meteorological or terrain information that is stored in a category-specific geographic database. The method also includes determining a current location of the search request. The method also includes performing a spatial search of the category-specific geographic database to determine one or more category-specific locations within a specified distance of the current location. The method also includes retrieve category-specific geographic information corresponding to the one or more category-specific locations having the particular category of meteorological or terrain information. The method also includes for each of the one or more category-specific locations: performing a search of a geographical name database to identify a geographical name associated with the category-specific location, and displaying the geographical name with the corresponding category-specific geographic information.

Another general aspect includes a method performed by one or more processors of a mobile device. The method also includes receiving a search request for information related to a particular category of meteorological or terrain information that is stored in a category-specific geographic database. The method also includes determining a first location based on the search request. The method also includes performing a category search of a geographical name database to identify one or more naming locations that are associated with the particular category of meteorological or terrain information and that are within a first specified distance of the first location. The method also includes for each of the one or more naming locations: performing a spatial search of the category-specific geographic database to determine one or more category-specific locations within a second specified distance of the naming location, retrieving category-specific geographic information corresponding to each naming location, and displaying the naming location with the corresponding category-specific geographic information.

These and other embodiments of the disclosure are described in detail below. For example, other embodiments are directed to systems, devices, and computer readable media associated with methods described herein.

A better understanding of the nature and advantages of embodiments of the present disclosure may be gained with reference to the following detailed description and the accompanying drawings.

### BRIEF DESCRIPTION OF THE DRAWINGS

FIG. 1 is a simplified functional diagram of a mobile device providing category-specific geographic applications (e.g., tide application), according to some embodiments.

FIG. 2A is a simplified diagram illustrating the relationship between tide locations, map locations, and merged locations, according to some embodiments.

FIG. 2B, is a simplified diagram illustrating locations surrounding a requested location based on keywords provided by a user, according to some embodiments.

FIG. 3 is a sequence diagram 300 illustrating a technique for providing nearby geographic information (e.g., a naming location on a map) for a particular category (e.g., tide), according to some embodiments.

FIGS. 4A-4C illustrates example user interfaces for displaying geographic information (e.g., a naming location on a map) for a particular category (e.g., tide), in accordance with some embodiments.

FIG. 5 is a flowchart 500 illustrating a method for providing nearby geographic information for a particular category, according to some embodiments.

FIG. 6 is a sequence diagram 600 illustrating a technique for adding a new location to a static list of category-specific locations (e.g., a naming location with tide information), according to some embodiments.

FIGS. 7A-7C illustrate example user interfaces for displaying an added category-specific location (e.g., a naming location with tide information), according to some embodiments.

FIG. 8 is a flowchart 800 illustrating a method for adding a new location to a static list of category-specific locations, according to some embodiments.

FIGS. 9 and 10 illustrate methods of application processes, in accordance with some embodiments.

FIG. 11 illustrates a device for performing API, in accordance with some embodiments.

FIG. 12 illustrates a system for performing API, in accordance with some embodiments.

FIGS. 13 and 14 illustrate data flows related to API processes, in accordance with some embodiments

FIG. 15 is a block diagram of an example device, which may be a mobile device, according to some embodiments.

### DETAILED DESCRIPTION

There are situations where a user of a mobile device (e.g., a mobile phone or a wearable watch) wants to identify relevant geographic information (e.g., meteorological information such as tides) near them, for example, nearby locations suitable for surfing (called surfing locations or tide locations). However, such geographic information might only be relevant to certain areas (e.g., ocean or coast), and such information may reside in a different database (e.g., tides database) than other geographic information (e.g., naming information in a map database). Additionally, a naming location (referred to as a map location) and a location with tide information (referred to as a tide location) may have some discrepancies because the location with tide information may be in an ocean having some distance from a user's current naming location. Therefore, there is a need to convey search results between different databases appropriately and effectively.

Furthermore, a user may like to add a new category-specific location (e.g., a surfing location) to an existing list of locations by using a location keyword search on a tide application (e.g., as part of a search of a name database), or using its current location as a starting point (e.g., as part of a spatial search of a category database). If the entered (or requested) location does not have tide-related information, adding such a location to the tide application may not be useful to a user (e.g., a surfer) interested in tide information. Sometimes, even if the user believes the entered/requested location is near a coast, which, however, may be next to a lake or pond near a coastal line, such a location may still have no tide-related information. Therefore, there is a need to enhance the user experience for adding a new location to a list of existing surfing locations.

Various techniques disclosed in the present disclosure can use two different databases, category-specific geographic database (e.g., for tide, and referred to as tides database) and a map database (also referred to as name-location database or geographical name database), to obtain a naming location with tide information (or tidal data, such as wave height and shape, break location, tide phases, etc.). The search result from the map database may be referred to as a map location. The search result from the tides database may be referred to as a tide location. The various databases may refer to different tables supported within a single database service.

To identify nearby surfing locations, a tide application may use the user's current location (on land) to search a tides database to find the closest tide locations (in the ocean). For each identified tide location, a search on a map database may be performed to find the name of the identified map location (on land) and associate it with the identified tide location with tide information. In other words, the techniques can associate (or merge) a tide location (i.e., a location with tide information lacking a name on a map) with a map location (i.e., a naming location on the map). Such a location that combines (or correlates or associates) these two information (e.g., map and tide) may be referred to as a merged location. The merged locations may be displayed on the mobile device with configurable indicators to reflect various distances between the tide locations and their corresponding map locations.

The techniques disclosed in the present disclosure may also enable a user to add a new category-specific location (e.g., using its current location or entering a new location into an application, such as a tide application) to a list of category-specific locations, e.g., an existing list of surfing locations. The application may use the current location's latitude and longitude information (or a name entered by the user) to perform a category search (e.g., special API returning category (e.g., ocean) adjacent map locations that are likely to be associated with tide information) on a map database, resulting in one or more names of the nearby locations (i.e., naming locations or map locations). The application may then use the result of the first search to filter these nearby naming locations by checking the tides database using the latitude and longitude information of each naming location, and display only the naming locations with tide information.

### I. Use of Tides and Map Databases

Identifying nearby surfing locations and adding a new surfing location to an existing list of locations may involve correlating or associating two different databases (tides database and map database), as discussed above.

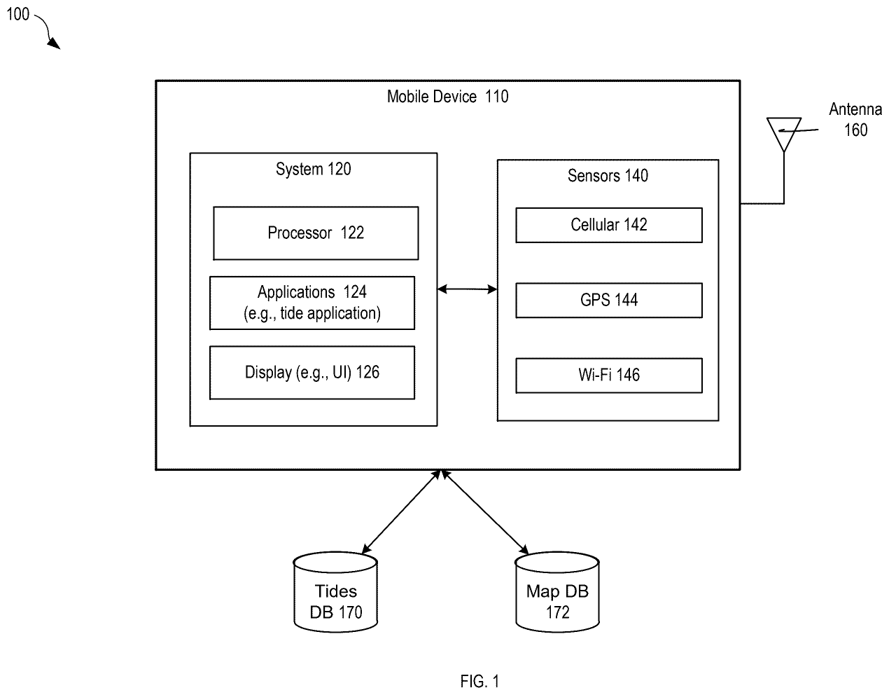

FIG. 1 illustrates a simplified functional diagram of a mobile device utilizing the disclosed techniques. As shown in FIG. 1, a mobile phone may include a system 120 that includes a processor 122, applications 124 (e.g., including a tide application), and display 126 (e.g., user interface), and sensors 140, such as cellular 142, global positioning system (GPS) 144, and wireless fidelity (Wi-Fi) 146. The sensors may be used to identify the current location of the user. The mobile phone 110 may be configured to access two databases, tides database 170 and map database 172.

A map database may include, but is not limited to, geographic data (e.g., roads, land topography, point of interest), spatial information (e.g., location coordinates such as latitude and longitude data), satellite imagery, metadata, etc. A tides database may include, but is not limited to, tide-related information (e.g., prediction of tide such as times of high/low tides, heights at specific times, wave shapes), geographic data (e.g., coastal locations, latitude and longitude coordinates of tide stations), metadata, etc. In some embodiments, the tides database may further include other databases for sea state data, such as swell and sea surface temperature.

For example, a tide application (part of applications 124) of a mobile device 110 (e.g., a wearable watch) can use a user's current location (e.g., latitude and longitude) to search a category-specific geographic database 170 (e.g., tides database) to find the closest location (or a list of locations) with tide information using the nearest neighbor calculation. Then, the first search result is used to look up a map database 172 (i.e., geographical name database) to find the name of the identified map location to associate with the tide information. As a result, merged locations (i.e., merging a map location and a tide location) can be generated. Because an actual tide location and its corresponding map location may have various distances, the merged location may be displayed with at least three configurable indicators (or indications) to reflect the distance between the tide location and its corresponding map location. The different indicators may be an arrow surrounded by a small ring (e.g., the distance is within 4 km), an arrow surrounded by a large ring (e.g., the distance is within 50 km), and showing “current location” (i.e., find nothing, e.g., the distance is more than 50 km apart).

In some embodiments, the disclosed techniques may apply to other categories, such as snow, wildfire, hurricane, and tornado. For example, a person may like to identify locations for skiing, or locations where wildfires have occurred.

Embodiments of the present disclosure provide a number of advantages/benefits. For example, the disclosed techniques can effectively correlate, associate, or integrate multiple specialized databases (e.g., map database, tides database, etc.) to provide useful information (e.g., merged locations) to a user, where each specialized database by itself may have limited use. By tapping into the strengths of each specialty and combining them to create new and useful information, such techniques can provide better services and enhance user experience. Furthermore, the disclosed techniques can also convert disjointed information (e.g., map locations and tide locations with various distance relationships, and tide information) into an easy-to-understand user interface for display on a mobile device.

### A. Relationship Between Tide Locations, Map Locations, and Merged Locations

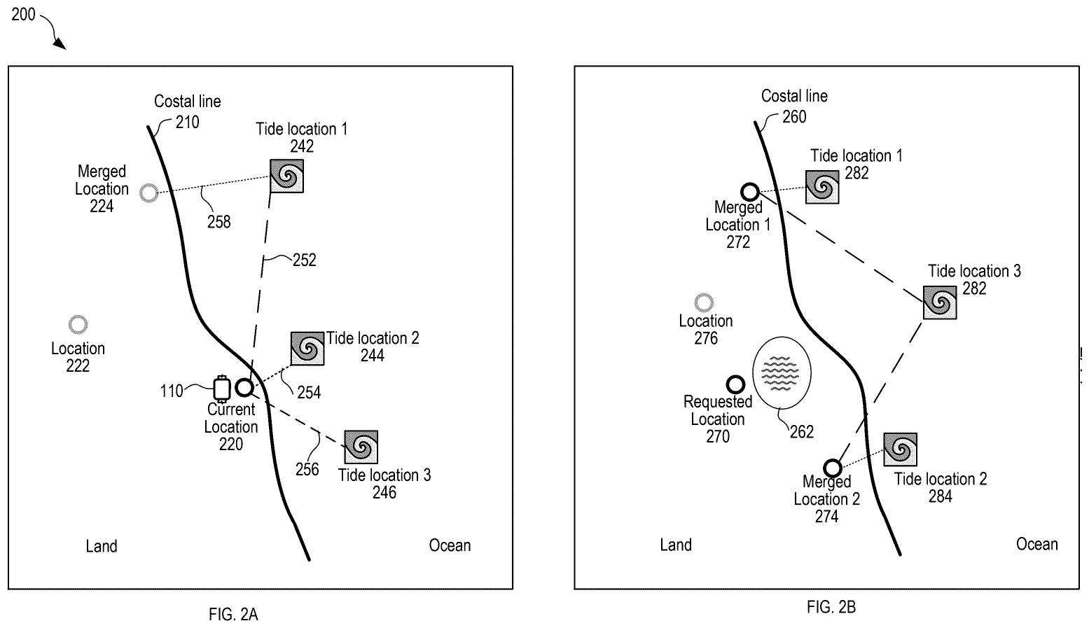

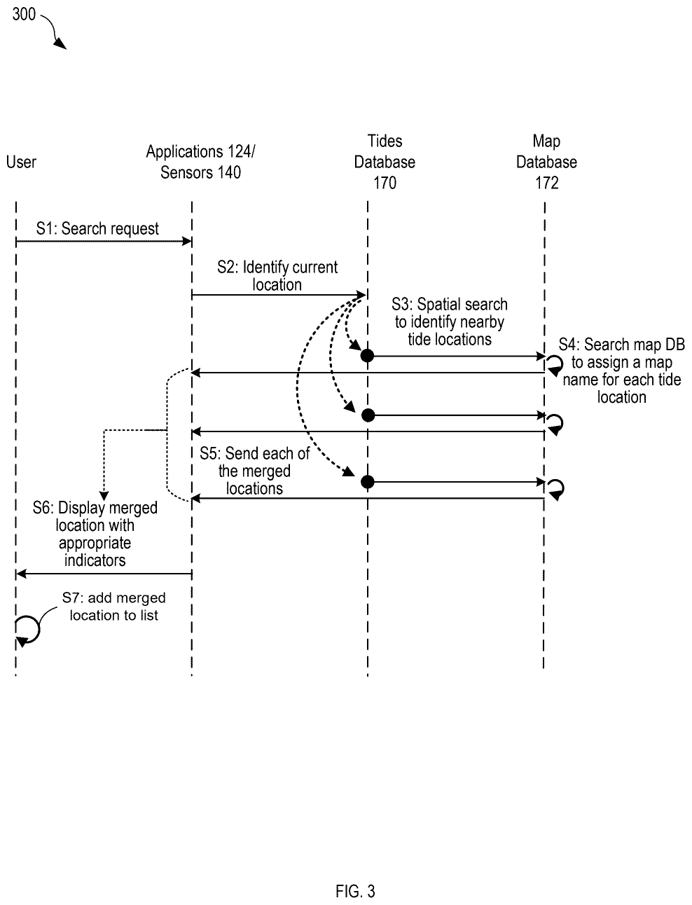

As discussed above, map locations and tide locations may have discrepancies and may be obtained from different databases. Certain processes (e.g., looking up both the tides database and map database, discussed below in section II) may be performed to correlate the information of these two types of locations (tide location and map location) to generate a merged location. FIG. 2A, illustrates the relationship between tide locations, map locations, and merged locations, according to some embodiments.

As shown in FIG. 2A, a user of a mobile device 110 may be at a location 220 (current location shown in a small black circle) along a coast line 210. The user may like to know a nearby location for surfing (called surfing locations) by launching a tide application on the mobile device 110. Suppose there is a tide location, location 1 242, location 2 244, or location 3 246, that can be found in a tide database; the distance relationship between the user's current location 220 on land and the tide location in the ocean may be divided into three ranges, for example, within 4 kilometers (km) (or short-range), within 50 km (or mid-range), and beyond 50 km (or long-range). Such distance relationship may be displayed on the mobile device 110 with different indicators (discussed below). For example, if the found tide location is tide location 2 244, the distance relationship is short-range (within 4 km). If the found tide location is tide location 3 246, the distance relationship is mid-range (within 50 km). if the found tide location is tide location 1 242, the distance relationship is long-range (beyond 50 km). In some embodiments, the distance relationship may be divided into fewer (e.g., two ranges) or more (e.g., five ranges) depending on applications. Thus, such information may allow the user to know how far it needs to travel to surf.

In further embodiments, the user may configure the tide application to search tide locations within a specific distance (or distance threshold) from its mobile device 110, such as 50 km. In such instance, the tide location 1 242 with the long-range distance relation may be considered not found. Thus, for either tide location 2 244 or tide location 3 246, the current location 220 may be considered as a merged location because location 220 is a map location that can be associated with the found tide locations (244 or 246) within the specified distance threshold.

Furthermore, in FIG. 2A, suppose the only found tide location is tide location 1 242, that is very far (e.g., beyond 50 km) from the current location 220 of the mobile device 110, but a location 224 (e.g., looked up via map database) on the land is closer to the found tide location 1 242 than the user's current location 220, the tide application may display the location 224 as a merged location because this location 224 on land (or map) is within the user's specified distance threshold such that the tide location 1 242 and the map location 224 can be correlated and merged.

In FIG. 2A, when the user is not using the tide application, a map application may display all locations (220, 222, and 224), regardless of whether they have associated tide information or not.

### B. Location Keyword Search to Find Merged Locations

When a user of a mobile device likes to add a new location to its existing list of surfing locations, it may enter a location (called entered or requested location) for a location keyword search, as discussed above. For example, a user may like to go on vacation to a resort, but does not know if there are any surfing locations around the resort. The tide application launched by the user may perform certain processes (discussed below in section III) to identify locations (e.g., merged locations) that can be associated with tide information around the requested location on the land.

FIG. 2B may illustrate locations surrounding a requested location based on keywords provided by a user, according to some embodiments. For example, in FIG. 2B, a user of a mobile device may enter a requested location 270 in a tide application to find nearby surfing locations around the requested location 270. The requested location 270 may be close to a coastline 260 but not a surfing location because it is actually next to lake 262. The tide application may try to find other map locations near the requested location 270 on the land and are close to the coastline by searching map database 172 of FIG. 1. For example, the tide application may identify locations 272, 274, and 276, that are close to the requested location 270. However, since location 276 is far from the coastline 260 and may be unlikely useful, location 276 may be filtered/removed. Therefore, the tide application may cross-check and look up the tides database 170 to associate the identified map locations (272 and 274) with tide locations (282 and 284) found in the tides database 170. As a result, the merged location 1 272 and merged location 2 274 may be displayed on the mobile device.

### II. Spatial Search of Category Database & Name Search

This section provides more details (e.g., a data flow (see subsection A), a user interface (see subsection B), and a flowchart (see subsection C)) of disclosed techniques for searching locations (e.g., surfing) close to the current location of a mobile device. As discussed above, displaying a merged location on a map may involve identifying category-specific geographic locations (e.g., tide locations) and displaying these locations on a map with names. Such a process may involve searches and cross-checking two different databases, a category-specific geographic database (e.g., tides database) and a geographical name database (e.g., map database).

### A. Data Flow for Identifying Nearby Geographic Information for A Particular Category

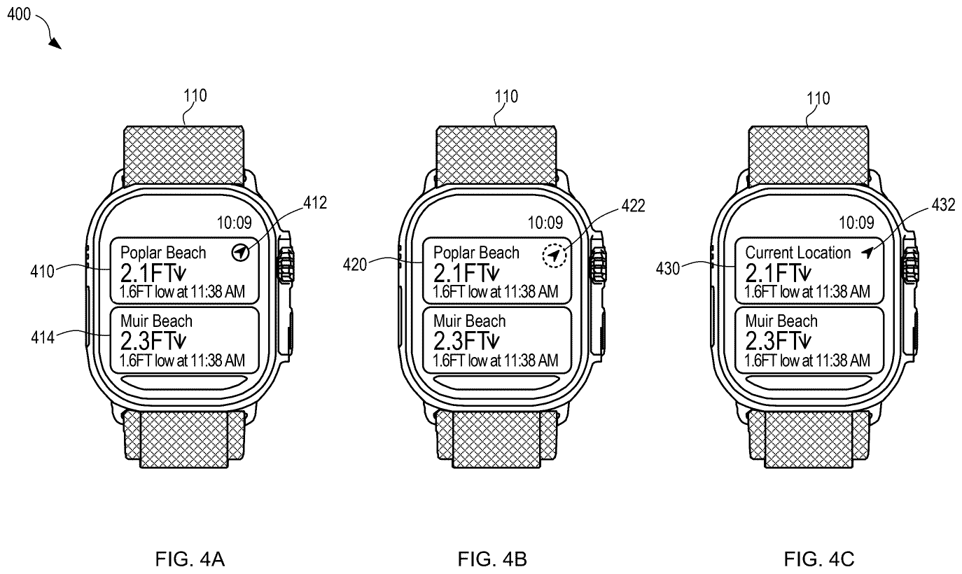

FIG. 3 is a sequence diagram 300 illustrating a technique for providing nearby geographic information (e.g., a naming location on a map) for a particular category (e.g., tide), according to some embodiments. As an example, a user of a mobile device at location 220 of FIG. 2A (e.g., San Jose, California (CA)) may be a surfer and like to know a nearby beach where the user can surf and the tide information for that beach.

At S1 of FIG. 3, the user can launch a tide application on its mobile device 110 to search for nearby surfing locations (i.e., a search request).

At S2, the tide application may use various location sensors 140, such as cellular 142, GPS 144, and Wi-Fi 146, of FIG. 1 to identify the latitude and longitude of the user's current location 220.

As S3, the tide application may look up a tides database (or tide-related databases) 170 using spatial search to identify one or more nearby tide locations (e.g., regions outside Santa Cruz or San Francisco in CA) that may be good for surfing, for example, locations in the ocean with tide information, such as tide locations 242, 244 and 246 of FIG. 2A. Each tide location may correspond to a geographic coordinate (e.g., latitude and longitude coordinate).

Spatial search can be any search that uses an input location (current or otherwise specified by a user) to identify database entries that are within a specified or default distance (or within a specified geographical region) as the input location. For example, an input location (e.g., the geographic coordinate of location 220 of FIG. 2A) can used to identify one or more tide locations (e.g., locations 242, 244, and 246 of FIG. 2A) in a tides database. Those skilled in the art will appreciate various ways and techniques that can be used to perform a spatial search of the category-specific geographic database to determine one or more category-specific locations within a specified distance of the current location. The techniques may include, but are not limited to, ball tree, geographic hash (Geohash), Rectangle-tree (R-tree), and the like.

For example, in some embodiments, spatial search may utilize a tree data structure (e.g., balanced tree or binary tree structure) stored in a database for search, where each tree node may contain a subset of data points. A query point (e.g., current location of a mobile device) may be defined to find the nearest neighbor (e.g., using k-nearest neighbor (KNN) search) by recursively traversing the tree while pruning branches having long distance from the query point. In other embodiments, spatial search may utilize a hierarchical grid of rectangular cells. Geographic coordinates of the world may be encoded into alphanumeric strings (e.g., “abc2xy”), and the world may be divided into rectangular cells, with each character representing a subdivision of the previous cell in the hierarchy. When receiving a search for a particular location (e.g., the current location of a mobile device), a search area may be defined, and proximity searches may be performed through the hierarchical structure.

At S4, each of the identified one or more tide locations may be used to search a map database 172 to find a map location (i.e., with a name on the map). The tide application can use an API with the latitude and longitude of the identified tide location to search the map database and filter the search results to map locations with geographic features available for surfing, or common beaches in California, for example, Santa Cruz beach, Ocean beach, and Half-moon bay, etc. In some embodiments, one map location closest to the tide location is selected and displayed, for example, map location 220 for tide location 244, and map location 224 for the tide location 242. In other embodiments, more than one map location surrounding the tide location may be selected and displayed. These final map locations with tide information (i.e., associated with tide locations) may be considered as the merged locations (220 and 224 of FIG. 2A).

At S5, the merged locations are sent from the map database 172 to the application (e.g., a tide application).

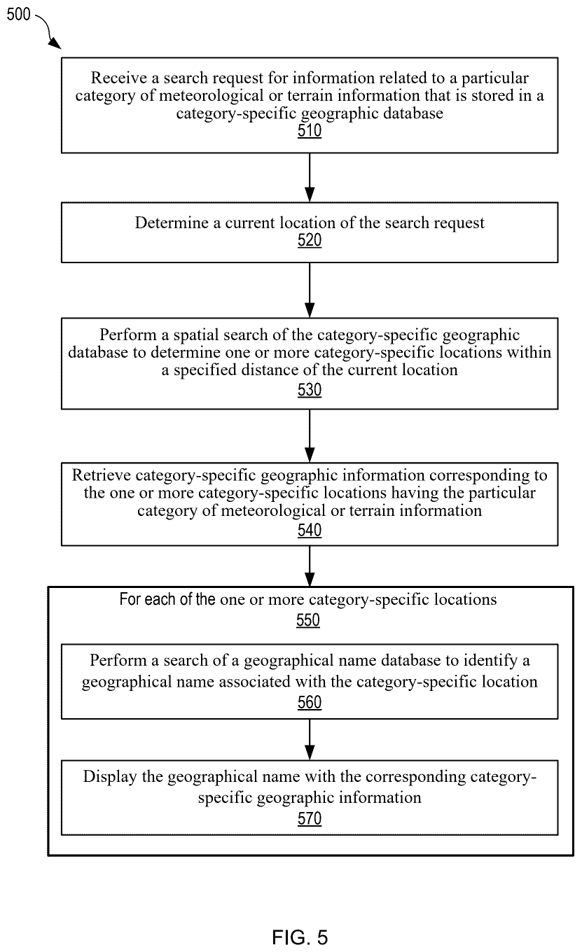

At S6, the merged locations (e.g., 220 and 224 of FIG. 2A) may be displayed on the mobile device 110 with appropriate indicators depending on the distance relationship between the location of the mobile device 110 on land and the tide location in the ocean. For example, if the mobile device is at location 220, the distance between tide location 2 244 and the mobile device may be within 4 km (dash line 254). Thus, an arrow surrounded by a small ring may be displayed (discussed below in FIG. 4A). If the mobile device is at location 224, the distance between tide location 1 242 and the mobile device may be within 50 km (dash line 258). An arrow surrounded by a large ring may be displayed (discussed below in FIG. 4B).

At S7, one or more merged locations can be selected and added to a list of such locations, e.g., surfing locations. Such adding can use user interfaces as described herein. For example, a selection of a geographical name for one of the corresponding category-specific locations can be received, and the selected geographical name can be added to a list of category-specific locations.

In some embodiments, there may be three different tide-related databases (i.e., parts of tides database 170), for example, a swell database, a tide database, and a sea surface temperature database. The tide application may correlate these three databases (or datasets) to provide more information to the user from the spatial search. These databases may include data from across the globe.

In certain embodiments, the spatial search for the tide-related databases may involve the following processes. The closest swell, sea temperature, and tide location are pre-calculated to every point on earth at 0.01-degree resolution using various techniques, such as ball tree. If a location has all three values within a pre-defined distance (e.g., 50-mile radius), that location is considered to be closer to water. The mapping of these three datasets for a given point based on the pre-defined distance may be stored as files (e.g., parquet files) on disk. When receiving a location from a user, the tide application may look up the pre-computed mappings to determine the closest point (i.e., the nearby tide location). The corresponding sea temperature, swell, and tide location information may be provided.

The tides database may be provided by a third-party provider, who uploads the tide data to the database once a day with the 24-hour forecast. The searched information may be cached for faster lookup in the future. For snow or wildfire databases, their data may be updated more frequently to reflect the changing nature of the meteorological or terrain information for accurate predictions and reports. The same techniques described in the present disclosure can apply to various geographic categories (e.g., tide, snow, wildfire, hurricane, etc.).

### B. User Interface

As discussed above in FIGS. 2A and 3, a merged location (i.e., a naming location on the map that has tide information) may be displayed on the mobile device 110 with appropriate indicators depending on the distance relationship between the location of the mobile device 110 on land and the tide location in the ocean. FIGS. 4A-4C illustrate example user interfaces for displaying geographic information (e.g., a naming location on a map) for a particular category (e.g., tide), in accordance with some embodiments.

Referring to FIGS. 2A and 4A-4C, location 220 of the mobile device 110 (e.g., a wearable watch) may be at a beach called Poplar Beach. There may be three identified tide locations from the tides database 170 with three different distance relationships with the mobile device 110, short-range (within 4 km) for tide location 2 244, mid-range (within 50 km) for tide location 3 246, and long-range (beyond 50 km) for tide location 1 242. If the distance threshold for searching tide locations is set to 50 km by the user, FIGS. 4A-4C may display these three different ranges, respectively.

For example, in FIG. 4A, since the tide location 244 and map location 220 (e.g., Poplar Beach) are close to each other (e.g., within 4 km), the map location (now called merged location 220), along with an indicator 412 indicating close distance, such as a small ring around an arrow, may be displayed on the user's mobile device 110 (e.g., wearable watch), shown in the upper platter 410. A platter may be an interactive software component that can display information (e.g., name of location, times, etc.) or provide quick access to specific application functions (e.g., map application). A set of platters may be organized or stacked together into a smart stack.

In FIG. 4B, since the tide location 246 and map location 220 are within a larger range (e.g., 50 km), the map location (now called merged location 220), along with an indicator 422 indicating a mid-range, such as a large ring around an arrow, may be displayed on the user's mobile device 110, shown in the upper platter 420.

In FIG. 4C, since the tide location 242 and the map location 220 are far apart (e.g., more than 50 km apart), the map location may be shown as “current location” 430 with an arrow 432 only, indicating that no tide information is found (i.e., no merged location).

In some embodiments, another merged location 224 (e.g., Muir beach), which is a map location with tide information or associated with tide location 1 242, may not be the current location of the mobile device 110, but can also be displayed on the mobile device, shown in the lower platter 414 of FIG. 4A.

### C. Flowchart

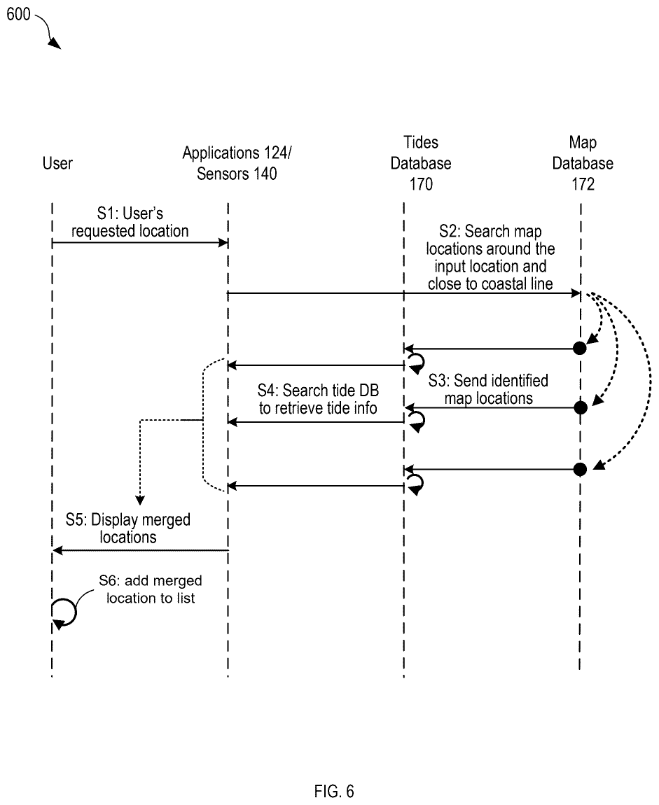

FIG. 5 is a flowchart 500 illustrating a method for providing nearby geographic information (e.g., a naming location on a map) for a particular category (e.g., tide), according to some embodiments.

At block 510, a search request for information related to a particular category of meteorological or terrain information (e.g., tide information) that is stored in a category-specific geographic database (e.g., tides database) may be received. For example, in FIGS. 1, 2A and 3, a user (e.g., a surfer) of a mobile device 110 (e.g., a wearable device such as a watch) may like to find a nearby beach where the user can surf. The user may launch a tide application on the mobile device 110 to initiate a search request to search tide information stored in the tides database 170.

At block 520, a current location of the search request may be determined. For example, in FIGS. 2A and 3, the current location of the user who invokes the tide application may be determined by the mobile device's location sensors, as discussed in S2 of FIG. 3.

At block 530, a spatial search of the category-specific geographic database may be performed to determine one or more category-specific locations (e.g., tide locations) within a specified distance of the current location. For example, in FIGS. 2A and 3, the tide application may use the latitude and longitude of the user's current location 220 to search (e.g., using spatial search) the tides database 170 to determine one or more tide locations within a specified distance (e.g., within 50 kilometers) of the current location 220, as discussed in S3 of FIG. 3.

At block 540, category-specific geographic information (e.g., geographic coordinate for tide) corresponding to the one or more category-specific locations having the particular category of meteorological or terrain information (e.g., tide information) may be retrieved. For example, in FIGS. 2A and 3, the geographic coordinate information (e.g., latitude and longitude coordinates of locations 242, 244, and 246) from the spatial search results corresponding to the one or more tide locations (e.g., 242, 244, and 246) with tide information (e.g., waves, break location, tide phases) may be retrieved from the tide database.

Block 550 includes blocks 560 and 570. At block 450, for each of the one or more category-specific locations, the processes in blocks 560 and 570 may be performed.

At block 560, a search of a geographical name database (e.g., map database) to identify a geographical name associated with the category-specific location. For example, in FIGS. 1, 2A and 3, for each tide location identified in block 540, the tide application may search a map database 172 to name the identified tide location. As discussed earlier, the tide location (e.g., 242 or 246) and a map location (e.g., 220) from the map database for naming the tide location may not be close to each other since the tide location in the tide database may be in an ocean while the map location in the map database is on land, as discussed in S4 of FIG. 3. The named tide location (i.e., assigning a name to a map location associated with a tide location) may become the merged location 220 with a name (e.g., as poplar beach) on the map on land.

At block 570, the geographical name with the corresponding category-specific geographic information is displayed. For example, in FIGS. 2A, 3 and 4, once the map location for naming the tide location (e.g., a geographic coordinate) is identified, the merged location (or named tide location) may be displayed on the user's mobile device. Depending on how far apart the tide location and map location, the merged location may be displayed in three different ways (as shown in FIGS. 4A-4C): the merged location (e.g., Poplar beach) along with an indicator 412 indicating close distance, such as a small ring around an arrow (e.g., if distance difference is within 4 km), as shown in FIG. 4A; the named map location along with an indicator 422 indicating a larger range, such as a large ring around an arrow (e.g., if the distance difference is within 50 km), as shown in FIG. 4B; and the user's current location (e.g., shown as “Current location”) with an arrow 432 only (e.g., if the distance difference is more than 50 km), as shown in FIG. 4C.

### III. Search of Name Database & Spatial Search

This section provides more details (e.g., a data flow (see subsection A), a user interface (see subsection B), and a flowchart (see subsection C)) of disclosed techniques for a user of a mobile device to identify and possibly add a new location or its current location to a list of locations (e.g., surfing locations) in a category (e.g., tide) application. The process may also involve searches and cross-checking two different databases, a category-specific geographic database (e.g., tides database) and a geographical name database (e.g., map database).

### A. Data Flow for Adding a New Location to a Static List of Category-Specific Locations

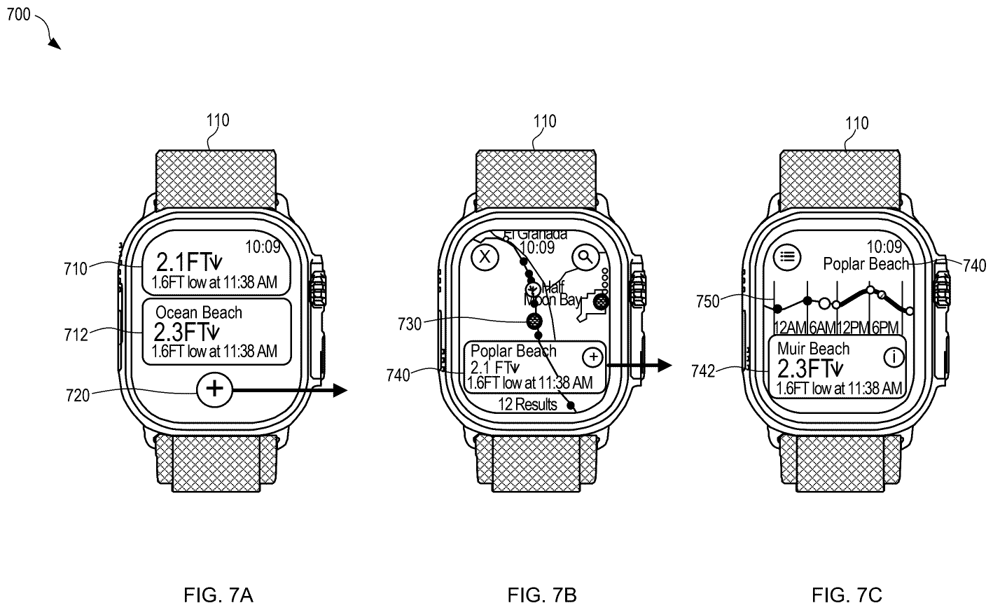

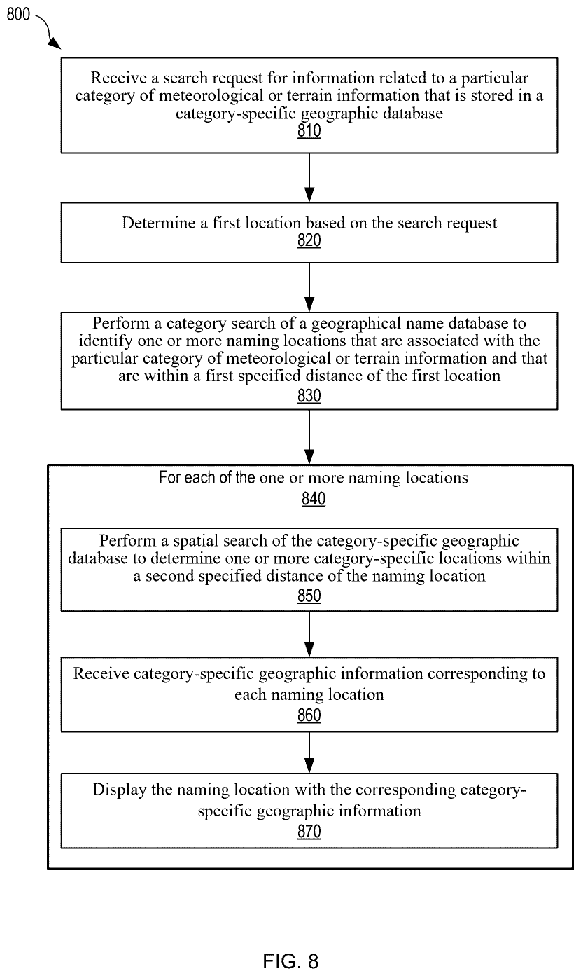

FIG. 6 is a sequence diagram 600 illustrating a technique for adding a new location to a static list of category-specific locations (e.g., a naming location with tide information), according to some embodiments. In FIG. 6, at S1, the user's requested location may be received by a tide application (also illustrated in FIG. 7A discussed below). For example, in FIG. 2B, the requested location 270 (e.g., a beach name, a city name, or a street address) may be a resort location entered by a user of a mobile device 110 for its planned vacation, or its current location determined by the location sensors of the mobile device 110.

At S2, the tide application may use the latitude and longitude of the requested location 270 to search a map database 172 of FIG. 1. A category search (e.g., special API returning category (e.g., ocean) adjacent map locations that are likely to be associated with tide information) may be performed on the map database to identify many map locations around the requested location 270 within a specified distance set by the user, but filters them down to map locations that are adjacent to coastline 260, such as a beach name, or a city with a beach, but not lakes 262. For example, the tide application may identify locations 270, 272, 274, and 276, that are close to the requested location 270. However, locations 270 and 276 may be filtered or removed because they are close to a lake or inland.

In some embodiments, if the user enters an address of a location, the category search may check whether the city covering the address has a beach. If the city has no beaches, the search may be expanded to nearby cities with beaches.

At S3, each of the selected map locations (e.g., 272 and 274) from the filtered list may be used by the tide application to perform a second search on the tides database 170.

At S4, for each selected map location (e.g., a beache), the tide application further performs a search (e.g., spatial search) in the tides database 170 using the latitude and longitude of the map location to find one or more tide locations with tide information and within the distance threshold (e.g., 50 km) specified by the user. For example, tide locations 282, 284, and 286 of FIG. 2B may be found in the tides database 170. However, tide location 286 may not be used because it is outside the distance threshold from either of the selected map locations 272 and 274.

At S5, those selected map locations (e.g., 272 and 274 of FIG. 2B) that have found associated tide locations (282 and 284) may become the merged locations (272 and 274), may be displayed on the user's wearable device (e.g., watch) along the coastline 260.

At S6, one or more merged locations can be selected and added to a list of such locations, e.g., surfing locations. Such adding can use user interfaces as described herein. For example, a selection of a geographical name for one of the corresponding category-specific locations can be received, and the selected geographical name can be added to a list of category- specific locations.

### B. User Interface

FIGS. 7A-7C illustrate example user interfaces for displaying an added category-specific location (e.g., a naming location with tide information, or merged locations) described above, according to some embodiments. In FIG. 7A, the tide application on a mobile device 110 may already have a list of surfing locations (e.g., 710 and 712). The tide application may have an option 720 that allows the user to enter a location keyword (e.g., a beach name, a city name, or a street address), for example, the requested location 270 of FIG. 2B.

In FIG. 7B, after the category search (as discussed in S2 of FIG. 6) and spatial search (as discussed in S4 of FIG. 6), the tide application may display the final merged locations 272 and 274 of FIG. 2B as dots (e.g., 730) on the mobile device 110. For each dot, a platter 740 with the name (e.g., Poplar Beach) of the tide location (i.e., now called merged location after the search processes) may be shown.

In FIG. 7C, the corresponding tide information may be displayed for the selected merged location. For example, if the user selects one of the two final merged locations 272 FIG. 2B (e.g., poplar Beach in platter 740 of FIG. 7B) and 274 FIG. 2B (e.g., Muir Beach 742 of FIG. 7B) of FIG. 2B, tide information 750 (e.g., GUI with time and height of tide) of the selected merged location 272 (e.g., poplar Beach in platter 740) may be displayed.

In some embodiments, after a user of a mobile device (e.g., watch) adds a location (e.g., a beach) to the static list of category-specific locations, every time the user approaches that beach, a set of platters (e.g., 740 and 742 of FIG. 7) containing information may appear at the lower part of the watch face when the user rolls the crown up. The set of platters is called a smart stack. The smart stack may include other compilations for various geographic categories.

### C. Flowchart

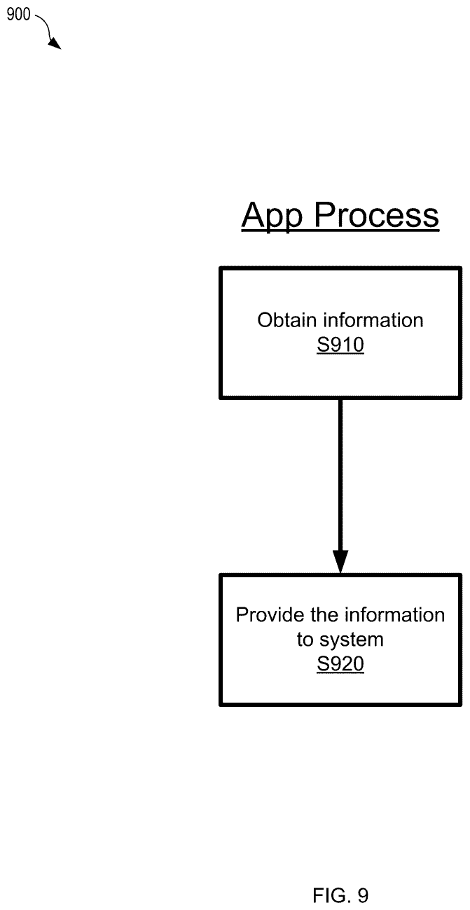

FIG. 8 is a flowchart 800 illustrating a method for searching for a location with corresponding category-specific geographic information. Additionally, embodiments can add a new location to a static list of category-specific locations, according to some embodiments.

At block 810, a search request for information related to a particular category of meteorological or terrain information (e.g., tide information) that is stored in a category-specific geographic database (e.g., tides database) may be received. For example, in FIGS. 2B, 6 and 7A, a user (e.g., a surfer) of a mobile device 110 (e.g., a wearable device such as a watch), who likes to add a requested location with tide information to its surfing list, may launch a tide application. The tide information may be stored in a tides database 170.

At block 820, a first location based on the search request is determined. For example, in FIGS. 2B, 6 and 7A, the first location may be the user's current location determined by location sensors (140 of FIG. 1) of the mobile device, or a location entered (e.g., 720 of FIG. 7A) by the user to initiate the search request.

At block 830, a category search of a geographical name database (e.g., map database) may be performed to identify one or more naming locations that are associated with the particular category of meteorological or terrain information and that are within a first specified distance of the first location. For example, in FIGS. 2B and 6, the tide application may use the latitude and longitude of the determined location in block 820 to search a map database based on an ocean category (i.e., category search), and filter the searched results down to map locations (e.g., 272 and 274 of FIG. 2B) that may have tides, such as beaches, not lakes, and within a first specified distance (e.g., 50 km), as discussed in S2 of FIG. 6.

Block 840 includes blocks 850, 860 and 870. At block 840, for each of the one or more naming locations, the processes in blocks 850, 860, and 870 may be performed.

At block 850, a spatial search of the category-specific geographic database (e.g., tides database) may be performed to determine one or more category-specific locations (e.g., tide locations) within a second specified distance of the naming location (e.g., map location). For example, in FIGS. 2B and 6, for each of the selected map locations (272 and 274 of FIG. 2B), the tide application further performs a search (e.g., spatial search) in the tides database 170 using the latitude and longitude of the map location to find one or more tide locations (e.g., 282 and 284 of FIG. 2B) with tide information and within a second specified distance (e.g., 50 km) set by the user, as discussed in S4 of FIG. 6. The first specified distance (e.g., for category search on land) and the second specified distance (e.g., for spatial search in the ocean) may or may not be the same. The selected map locations that have found associated tide locations (282 and 284) may become the merged locations (272 and 274).

At block 860, category-specific geographic information corresponding to each naming location may be retrieved. For example, the tide information (e.g., 750 of FIG. 7C) for each of merged locations (272 and 274 of FIG. 2B) identified in block 850 may be retrieved.

At block 870, the geographical name with the corresponding category-specific geographic information may be displayed. As discussed above, these merged locations (272 and 274 of FIG. 2B) may be displayed on the user's wearable device (e.g., watch) as dots (e.g., 730 of FIG. 7B) along a coastline. For each dot, a platter (e.g., 740 of FIG. 7B) with the name of each tide location (i.e., now called merged location after the search processes) is shown. The corresponding tide information (e.g., 750 of FIG. 7C, such as GUI with time and height of tide) may be displayed for the selected merged location (e.g., Poplar Beach in platter 740 of FIG. 7B).

### IV. Application Programming Interface

Implementations within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, widgets, processes, software, and/or components.

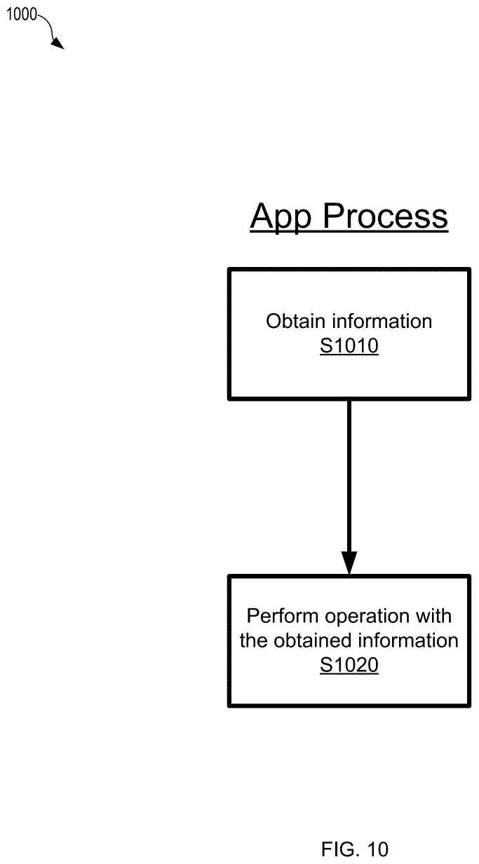

Implementations within the scope of the present disclosure include a computer-readable storage medium that encodes instructions organized as an application (e.g., application 1120) that, when executed by one or more processing units, control an electronic device (e.g., device 1110) to perform the method of FIG. 9, the method of FIG. 10, and/or one or more other processes and/or methods described herein.

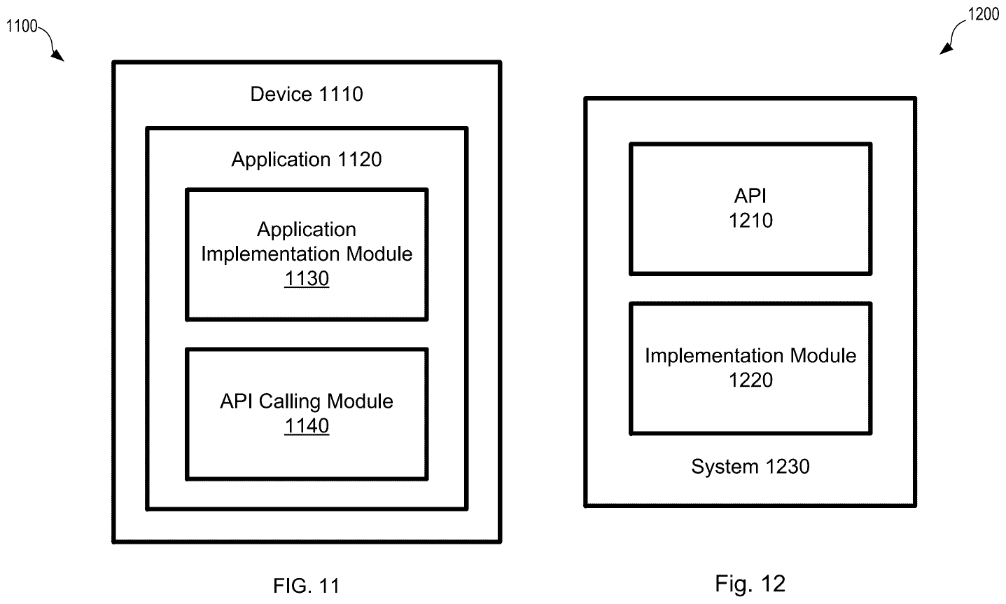

It should be recognized that application 1120 (shown in FIG. 11) can be any suitable type of application, including, for example, one or more of: an accessory companion application, a browser application, an application that functions as an execution environment for plug-ins, widgets or other applications, a fitness application, a health application, a digital payments application, a media application, a social network application, a messaging application, and/or a maps application. In some embodiments, application 1120 is an application that is pre-installed on device 1110 at purchase (e.g., a first party application). In other embodiments, application 1120 is an application that is provided to device 1110 via an operating system update file (e.g., a first party application or a second party application). In other embodiments, application 1120 is an application that is provided via an application store. In some embodiments, the application store can be an application store that is pre-installed on device 1110 at purchase (e.g., a first party application store). In other embodiments, the application store is a third-party application store (e.g., an application store that is provided by another application store, downloaded via a network, and/or read from a storage device).

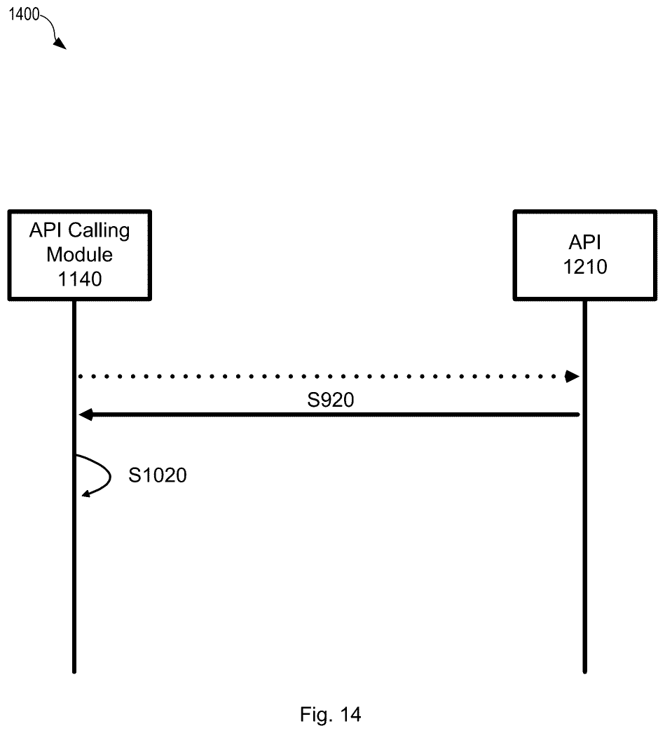

Referring to FIG. 9 and FIG. 13, application 1120 obtains information (e.g., S910). In some embodiments, at S910, information is obtained from at least one hardware component of the device 1110. In some embodiments, at S910, information is obtained from at least one software module of the device 1110. In some embodiments, at S910, information is obtained from at least one hardware component external to the device 1110 (e.g., a peripheral device, an accessory device, a server, etc.). In some embodiments, the information obtained at S910 includes positional information, time information, notification information, user information, environment information, electronic device state information, weather information, media information, historical information, event information, hardware information, and/or motion information. In some embodiments, in response to and/or after obtaining the information at S910, application 1120 provides the information to a system (e.g., S920).

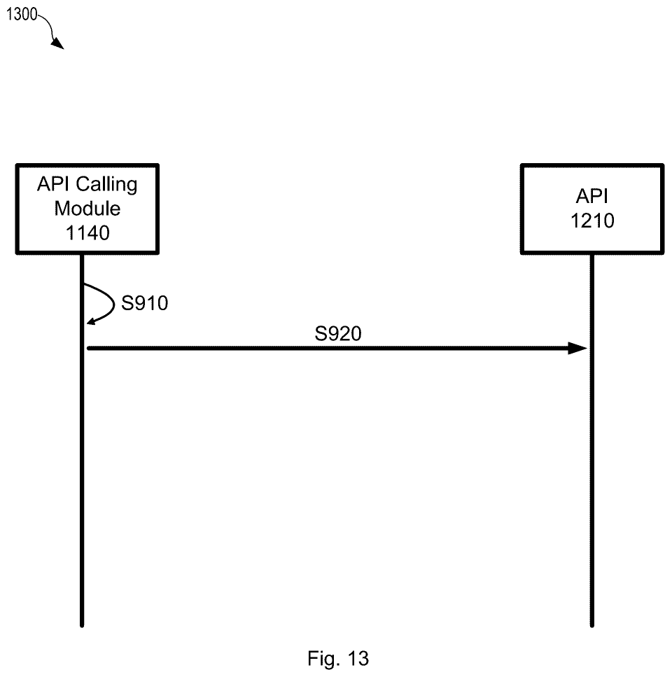

In some embodiments, the system (e.g., 1230 shown in FIG. 12) is an operating system hosted on the device 1110. In some embodiments, the system (e.g., 1230 shown in FIG. 12) is an external device (e.g., a server, a peripheral device, an accessory, a personal computing device, etc.) that includes an operating system.

Referring to FIG. 10 and FIG. 14, application 1120 obtains information (e.g., S1010). In some embodiments, the information obtained at S1010 includes positional information, time information, notification information, user information, environment information electronic device state information, weather information, media information, historical information, event information, hardware information and/or motion information. In response to and/or after obtaining the information at S1010, application 1120 performs an operation with the information (e.g., S1020). In some embodiments, the operation performed at S1020 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 1230 based on the information.

In some embodiments, one or more steps of the method of FIG. 9 and/or the method of FIG. 10 is performed in response to a trigger. In some embodiments, the trigger includes detection of an event, a notification received from system 1230, a user input, and/or a response to a call to an API provided by system 1230.

In some embodiments, the instructions of application 1120, when executed, control device 1110 to perform the method of FIG. 9 and/or the method of FIG. 10 by calling an application programming interface (API) (e.g., API 1210) provided by system 1230. In some embodiments, application 1120 performs at least a portion of the method of FIG. 9 and/or the method of FIG. 10 without calling API 1210.

In some embodiments, one or more steps of the method of FIG. 9 and/or the method of FIG. 10 includes calling an API (e.g., API 1210) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 11, device 1110 is illustrated. In some embodiments, device 1110 is a personal computing device, a smart phone, a smart watch, a fitness tracker, a head mounted display (HMD) device, a media device, a communal device, a speaker, a television, and/or a tablet. As illustrated in FIG. 11, device 1110 includes application 1120 and operating system (e.g., system 1230 shown in FIG. 12). Application 1120 includes application implementation module 1130 and API calling module 1140. System 1230 includes API 1210 and implementation module 1220. It should be recognized that device 1110, application 1120, and/or system 1230 can include more, fewer, and/or different components than illustrated in FIGS. 11 and 12.

In some embodiments, application implementation module 1130 includes a set of one or more instructions corresponding to one or more operations performed by application 1120. For example, when application 1120 is a messaging application, application implementation module 1130 can include operations to receive and send messages. In some embodiments, application implementation module 1130 communicates with API calling module to communicate with system 1230 via API 1210 (shown in FIG. 12).

In some embodiments, API 1210 is a software module (e.g., a collection of computer-readable instructions) that provides an interface that allows a different module (e.g., API calling module 1140) to access and/or use one or more functions, methods, procedures, data structures, classes, and/or other services provided by implementation module 1220 of system 1230. For example, API-calling module 1140 can access a feature of implementation module 1220 through one or more API calls or invocations (e.g., embodied by a function or a method call) exposed by API 1210 and can pass data and/or control information using one or more parameters via the API calls or invocations. In some embodiments, API 1210 allows application 1120 to use a service provided by a Software Development Kit (SDK) library. In other embodiments, application 1120 incorporates a call to a function or method provided by the SDK library and provided by API 1210 or uses data types or objects defined in the SDK library and provided by API 1210. In some embodiments, API-calling module 1140 makes an API call via API 1210 to access and use a feature of implementation module 1220 that is specified by API 1210. In such embodiments, implementation module 1220 can return a value via API 1210 to API-calling module 1140 in response to the API call. The value can report to application 1120 the capabilities or state of a hardware component of device 1110, including those related to aspects such as input capabilities and state, output capabilities and state, processing capability, power state, storage capacity and state, and/or communications capability. In some embodiments, API 1210 is implemented in part by firmware, microcode, or other low level logic that executes in part on the hardware component.

In some embodiments, API 1210 allows a developer of API-calling module 1140 (which can be a third-party developer) to leverage a feature provided by implementation module 1220. In such embodiments, there can be one or more API-calling modules (e.g., including API-calling module 1140) that communicate with implementation module 1220. In some embodiments, API 1210 allows multiple API-calling modules written in different programming languages to communicate with implementation module 1220 (e.g., API 1210 can include features for translating calls and returns between implementation module 1220 and API-calling module 1140) while API 1210 is implemented in terms of a specific programming language. In some embodiments, API-calling module 1140 calls APIs from different providers such as a set of APIs from an OS provider, another set of APIs from a plug-in provider, and/or another set of APIs from another provider (e.g., the provider of a software library) or creator of the another set of APIs.

Examples of API 1210 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a bluetooth API, an NFC API, a UWB API, a fitness API, a smart home API, contact transfer API, photos API, camera API, and/or image processing API. In some embodiments the sensor API is an API for accessing data associated with a sensor of device 1110. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation module 1220 is an system (e.g., operating system, server system) software module (e.g., a collection of computer-readable instructions) that is constructed to perform an operation in response to receiving an API call via API 1210. In some embodiments, implementation module 1220 is constructed to provide an API response (via API 1210) as a result of processing an API call. By way of example, implementation module 1220 and API-calling module 180 can each be any one of an operating system, a library, a device driver, an API, an application program, or other module. It should be understood that implementation module 1220 and API-calling module 1140 can be the same or different type of module from each other. In some embodiments, implementation module 1220 is embodied at least in part in firmware, microcode, or other hardware logic.

In some embodiments, implementation module 1220 returns a value through API 1210 in response to an API call from API-calling module 1140. While API 1210 defines the syntax and result of an API call (e.g., how to invoke the API call and what the API call does), API 1210 might not reveal how implementation module 1220 accomplishes the function specified by the API call. Various API calls are transferred via the one or more application programming interfaces between API-calling module 1140 and implementation module 1220. Transferring the API calls can include issuing, initiating, invoking, calling, receiving, returning, and/or responding to the function calls or messages. In other words, transferring can describe actions by either of API-calling module 1140 or implementation module 1220. In some embodiments, a function call or other invocation of API 1210 sends and/or receives one or more parameters through a parameter list or other structure.

In some embodiments, implementation module 1220 provides more than one API, each providing a different view of or with different aspects of functionality implemented by implementation module 1220. For example, one API of implementation module 1220 can provide a first set of functions and can be exposed to third party developers, and another API of implementation module 1220 can be hidden (e.g., not exposed) and provide a subset of the first set of functions and also provide another set of functions, such as testing or debugging functions which are not in the first set of functions. In some embodiments, implementation module 1220 calls one or more other components via an underlying API and thus be both an API calling module and an implementation module. It should be recognized that implementation module 1220 can include additional functions, methods, classes, data structures, and/or other features that are not specified through API 1210 and are not available to API calling module 1140. It should also be recognized that API calling module 1140 can be on the same system as implementation module 1220 or can be located remotely and access implementation module 1220 using API 1210 over a network. In some embodiments, implementation module 1220, API 1210, and/or API-calling module 1140 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

In some embodiments, method 700 (FIG. 7) is performed at a first computer system (as described herein) via a system process (e.g., an operating system process, a server system process) that is different from one or more applications executing and/or installed on the first computer system.

In some embodiments, method 700 (FIG. 7) is performed at a first computer system (as described herein) by an application that is different from a system process. In some embodiments, the instructions of the application, when executed, control the first computer system to perform method 700 (FIG. 7) by calling an application programming interface (API) provided by the system process. In some embodiments, the application performs at least a portion of method 700 without calling the API.

In some embodiments, the application is an accessory companion application that is constructed for processing communication and management between the first computer system and an accessory device (e.g., a wearable device, such as, for example, a watch).

In some embodiments, the application is an application that is pre-installed on the first computer system at purchase (e.g., a first party application). In other embodiments, the application is an application that is provided to the first computer system via an operating system update file (e.g., a first party application). In other embodiments, the application is an application that is provided via an application store. In some implementations, the application store is pre-download installed on the first computer system at purchase (e.g., a first party application store) and allows of one or more applications. In some embodiments, the application store is a third party application store (e.g., an application store that is provided by another device, downloaded via a network, and/or read from a storage device). In some embodiments, the application is a third party application (e.g., an app that is provided by an application store, downloaded via a network, and/or read from a storage device). In some embodiments, the application controls the first computer system to perform method 700 (FIG. 7) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a bluetooth API, an NFC API, a UWB API, a fitness API, a smart home API, contact transfer API, photos API, camera API, and/or image processing API.

In some embodiments, at least one API is a software module (e.g., a collection of computer-readable instructions) that provides an interface that allows a different module (e.g., API calling module) to access and use one or more functions, methods, procedures, data structures, classes, and/or other services provided by an implementation module of the system process. The API can define one or more parameters that are passed between the API calling module and the implementation module. In some embodiments, the API 1210 defines a first API call that can be provided by API calling module 1210, wherein the definition for the first API call specifies the following call parameters: distance thresholds for searching map locations in a map database and tide locations in a tides database, configurable indicators for displaying distance relationship between a map location and a tide location, etc. The implementation module is an system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 1110) that runs the application. In some embodiments, the implementation module is included in an electronic device that is separate from the device that runs the application.

### V. Example Device

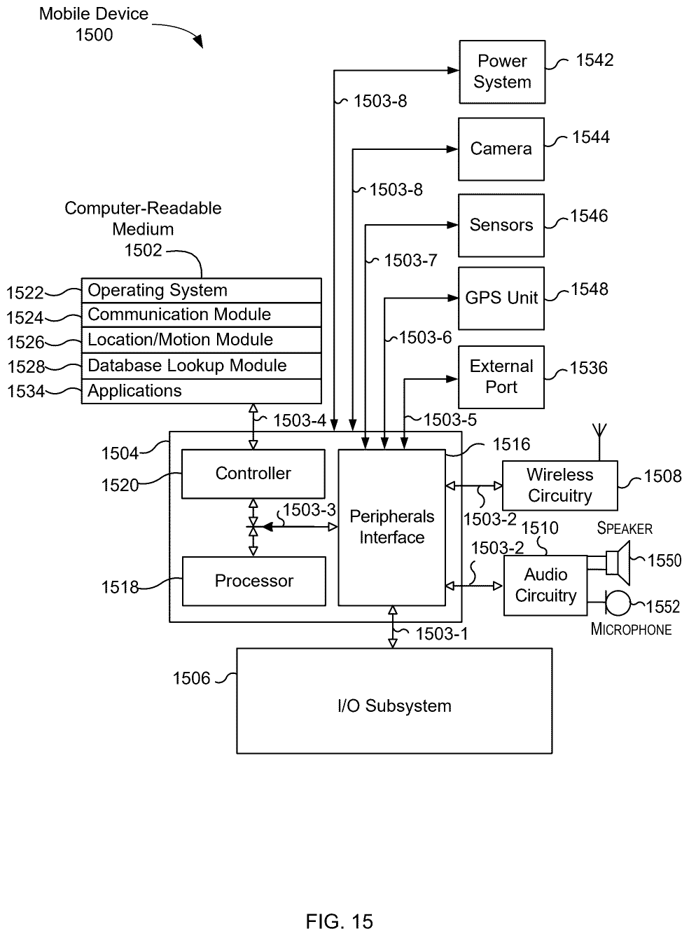

FIG. 15 is a block diagram of an example device 1500, which may be a mobile device. Device 1500 generally includes computer-readable medium 1502, a processing system 1504, an Input/Output (I/O) subsystem 1506, wireless circuitry 1508, and audio circuitry 1510 including speaker 1550 and microphone 1552. These components may be coupled by one or more communication buses or signal lines 1503. Device 1500 can be any portable mobile device, including a handheld computer, a tablet computer, a mobile phone, laptop computer, tablet device, media player, personal digital assistant (PDA), a key fob, a car key, an access card, a multi-function device, a mobile phone, a portable gaming device, a car display unit, or the like, including a combination of two or more of these items.

It should be apparent that the architecture shown in FIG. 15 is only one example of an architecture for device 1500, and that device 1500 can have more or fewer components than shown, or a different configuration of components. The various components shown in FIG. 15 can be implemented in hardware, software, or a combination of both hardware and software, including one or more signal processing and/or application specific integrated circuits.

Wireless circuitry 1508 is used to send and receive information over a wireless link or network to one or more other devices' conventional circuitry such as an antenna system, an RF transceiver, one or more amplifiers, a tuner, one or more oscillators, a digital signal processor, a CODEC chipset, memory, etc. Wireless circuitry 1508 can use various protocols, e.g., as described herein.

Wireless circuitry 1508 is coupled to processing system 1504 via peripherals interface 1516. Interface 1516 can include conventional components for establishing and maintaining communication between peripherals and processing system 1504. Voice and data information received by wireless circuitry 1508 (e.g., in speech recognition or voice command applications) is sent to one or more processors 1518 via peripherals interface 1516. One or more processors 1518 are configurable to process various data formats for one or more application programs 1534 stored on medium 1502.

Peripherals interface 1516 couple the input and output peripherals of the device to processor 1518 and computer-readable medium 1502. One or more processors 1518 communicate with computer-readable medium 1502 via a controller 1520. Computer-readable medium 1502 can be any device or medium that can store code and/or data for use by one or more processors 1518. Medium 1502 can include a memory hierarchy, including cache, main memory, and secondary memory.

Device 1500 also includes a power system 1542 for powering the various hardware components. Power system 1542 can include a power management system, one or more power sources (e.g., battery, alternating current (AC)), a recharging system, a power failure detection circuit, a power converter or inverter, a power status indicator (e.g., a light emitting diode (LED)), and any other components typically associated with the generation, management, and distribution of power in mobile devices.

In some embodiments, device 1500 includes a camera 1544. In some embodiments, device 1500 includes sensors 1546. Sensors 1546 can include accelerometers, compasses, gyrometers, pressure sensors, audio sensors, light sensors, barometers, and the like. Sensors 1546 can be used to sense location aspects, such as auditory or light signatures of a location.

In some embodiments, device 1500 can include a GPS receiver, sometimes referred to as a GPS unit 1548. A mobile device can use a satellite navigation system, such as the Global Positioning System (GPS), to obtain position information, timing information, altitude, or other navigation information. During operation, the GPS unit can receive signals from GPS satellites orbiting the Earth. The GPS unit analyzes the signals to make a transit time and distance estimation. The GPS unit can determine the current position (current location) of the mobile device. Based on these estimations, the mobile device can determine a location fix, altitude, and/or current speed. A location fix can be geographical coordinates such as latitudinal and longitudinal information. In other embodiments, device 1500 may be configured to identify GLONASS signals, or any other similar type of satellite navigational signal.

One or more processors 1518 run various software components stored in medium 1502 to perform various functions for device 1500. In some embodiments, the software components include an operating system 1522, a communication module (or set of instructions) 1524, a location module (or set of instructions) 1526, a database lookup module 1528, a predicted app manager module 1530, and other applications (or set of instructions) 1534, such as a car locator app and a navigation app.

Operating system 1522 can be any suitable operating system, including iOS, Mac OS, Darwin, RTXC, LINUX, UNIX, OS X, WINDOWS, or an embedded operating system such as Vx Works. The operating system can include various procedures, sets of instructions, software components and/or drivers for controlling and managing general system tasks (e.g., memory management, storage device control, power management, etc.) and facilitates communication between various hardware and software components.

Communication module 1524 facilitates communication with other devices over one or more external ports 1536 or via wireless circuitry 1508 and includes various software components for handling data received from wireless circuitry 1508 and/or external port 1536. External port 1536 (e.g., USB, FireWire, Lightning connector, 60-pin connector, etc.) is adapted for coupling directly to other devices or indirectly over a network (e.g., the Internet, wireless LAN, etc.).

Location/motion module 1526 can assist in determining the current position (e.g., coordinates or other geographic location identifier) and motion of device 1500. Modern positioning systems include satellite based positioning systems, such as Global Positioning System (GPS), cellular network positioning based on “cell IDs,” and Wi-Fi positioning technology based on a Wi-Fi networks. GPS also relies on the visibility of multiple satellites to determine a position estimate, which may not be visible (or have weak signals) indoors or in “urban canyons.” In some embodiments, location/motion module 1526 receives data from GPS unit 1548 and analyzes the signals to determine the current position of the mobile device. In some embodiments, location/motion module 1526 can determine a current location using Wi-Fi or cellular location technology. For example, the location of the mobile device can be estimated using knowledge of nearby cell sites and/or Wi-Fi access points with knowledge also of their locations. Information identifying the Wi-Fi or cellular transmitter is received at wireless circuitry 1508 and is passed to location/motion module 1526. In some embodiments, the location module receives the one or more transmitter IDs. In some embodiments, a sequence of transmitter IDs can be compared with a reference database (e.g., Cell ID database, Wi-Fi reference database) that maps or correlates the transmitter IDs to position coordinates of corresponding transmitters, and computes estimated position coordinates for device 1500 based on the position coordinates of the corresponding transmitters. Regardless of the specific location technology used, location/motion module 1526 receives information from which a location fix can be derived, interprets that information, and returns location information, such as geographic coordinates, latitude/longitude, or other location fix data.

Database lookup module 1528 can include various sub-modules or systems, e.g., as described herein with respect to FIGS. 2 and 4.

The one or more application programs 1534 on the mobile device can include any applications installed on the device 1500, including without limitation, a browser, address book, contact list, email, instant messaging, word processing, keyboard emulation, widgets, JAVA-enabled applications, encryption, digital rights management, voice recognition, voice replication, a music player (which plays back recorded music stored in one or more files, such as MP3 or AAC files), etc.

There may be other modules or sets of instructions (not shown), such as a graphics module, a time module, etc. For example, the graphics module can include various conventional software components for rendering, animating, and displaying graphical objects (including without limitation text, web pages, icons, digital images, animations, and the like) on a display surface. In another example, a timer module can be a software timer. The timer module can also be implemented in hardware. The time module can maintain various timers for any number of events.

The I/O subsystem 1506 can be coupled to a display system (not shown), which can be a touch-sensitive display. The display system displays visual output to the user in a GUI. The visual output can include text, graphics, video, and any combination thereof. Some or all of the visual output can correspond to user-interface objects. A display can use LED (light emitting diode), LCD (liquid crystal display) technology, or LPD (light emitting polymer display) technology, although other display technologies can be used in other embodiments.

In some embodiments, I/O subsystem 1506 can include a display and user input devices such as a keyboard, mouse, and/or track pad. In some embodiments, I/O subsystem 1506 can include a touch-sensitive display. A touch-sensitive display can also accept input from the user based on haptic and/or tactile contact. In some embodiments, a touch-sensitive display forms a touch-sensitive surface that accepts user input. The touch-sensitive display/surface (along with any associated modules and/or sets of instructions in medium 1502) detects contact (and any movement or release of the contact) on the touch-sensitive display and converts the detected contact into interaction with user-interface objects, such as one or more soft keys, that are displayed on the touch screen when the contact occurs. In some embodiments, a point of contact between the touch-sensitive display and the user corresponds to one or more digits of the user. The user can make contact with the touch-sensitive display using any suitable object or appendage, such as a stylus, pen, finger, and so forth. A touch-sensitive display surface can detect contact and any movement or release thereof using any suitable touch sensitivity technologies, including capacitive, resistive, infrared, and surface acoustic wave technologies, as well as other proximity sensor arrays or other elements for determining one or more points of contact with the touch-sensitive display.

Further, the I/O subsystem can be coupled to one or more other physical control devices (not shown), such as pushbuttons, keys, switches, rocker buttons, dials, slider switches, sticks, LEDs, etc., for controlling or performing various functions, such as power control, speaker volume control, ring tone loudness, keyboard input, scrolling, hold, menu, screen lock, clearing and ending communications and the like. In some embodiments, in addition to the touch screen, device 1500 can include a touchpad (not shown) for activating or deactivating particular functions. In some embodiments, the touchpad is a touch-sensitive area of the device that, unlike the touch screen, does not display visual output. The touchpad can be a touch-sensitive surface that is separate from the touch-sensitive display, or an extension of the touch-sensitive surface formed by the touch-sensitive display.

In some embodiments, some or all of the operations described herein can be performed using an application executing on the user's device. Circuits, logic modules, processors, and/or other components may be configured to perform various operations described herein. Those skilled in the art will appreciate that, depending on implementation, such configuration can be accomplished through design, setup, interconnection, and/or programming of the particular components and that, again depending on implementation, a configured component might or might not be reconfigurable for a different operation. For example, a programmable processor can be configured by providing suitable executable code; a dedicated logic circuit can be configured by suitably connecting logic gates and other circuit elements; and so on.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission. A suitable non-transitory computer readable medium can include random access memory (RAM), a read only memory (ROM), a magnetic medium such as a hard-drive or a floppy disk, or an optical medium, such as a compact disk (CD) or DVD (digital versatile disk), flash memory, and the like. The computer readable medium may be any combination of such storage or transmission devices.

Computer programs incorporating various features of the present disclosure may be encoded on various computer readable storage media; suitable media include magnetic disk or tape, optical storage media, such as compact disk (CD) or DVD (digital versatile disk), flash memory, and the like. Computer readable storage media encoded with the program code may be packaged with a compatible device or provided separately from other devices. In addition, program code may be encoded and transmitted via wired optical, and/or wireless networks conforming to a variety of protocols, including the Internet, thereby allowing distribution, e.g., via Internet download. Any such computer readable medium may reside on or within a single computer product (e.g., a solid state drive, a hard drive, a CD, or an entire computer system), and may be present on or within different computer products within a system or network. A computer system may include a monitor, printer, or other suitable display for providing any of the results mentioned herein to a user.

As described above, one aspect of the present technology is the gathering and use of data available from various sources to improve prediction of users that a user may be interested in communicating with. The present disclosure contemplates that in some instances, this gathered data may include personal information data that uniquely identifies or can be used to contact or locate a specific person. Such personal information data can include demographic data, location- based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to predict users that a user may want to communicate with at a certain time and place. Accordingly, use of such personal information data included in contextual information enables people centric prediction of people a user may want to interact with at a certain time and place. Further, other uses for personal information data that benefit the user are also contemplated by the present disclosure. For instance, health and fitness data may be used to provide insights into a user's general wellness or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of people centric prediction services, the present technology can be configured to allow users to select to “opt in” or “opt out” of participation in the collection of personal information data during registration for services or anytime thereafter. In another example, users can select not to provide location information for recipient suggestion services. In yet another example, users can select to not provide precise location information, but permit the transfer of location zone information. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, users that a user may want to communicate with at a certain time and place may be predicted based on non-personal information data or a bare minimum amount of personal information, such as the content being requested by the device associated with a user, other non-personal information, or publicly available information.

Although the disclosure has been described with respect to specific embodiments, it will be appreciated that the disclosure is intended to cover all modifications and equivalents within the scope of the following claims.

All patents, patent applications, publications, and descriptions mentioned herein are incorporated by reference in their entirety for all purposes. None is admitted to be prior art. Where a conflict exists between the instant application and a reference provided herein, the instant application shall dominate.

What is claimed is:

1. A method performed by one or more processors of a mobile device, comprising:
receiving a search request for information related to a particular category of meteorological or terrain information that is stored in a category-specific geographic database;
determining a current location of the search request;
performing a spatial search of the category-specific geographic database to determine one or more category-specific locations within a specified distance of the current location;
retrieve category-specific geographic information corresponding to the one or more category-specific locations having the particular category of meteorological or terrain information;
for each of the one or more category-specific locations:
performing a search of a geographical name database to identify a geographical name associated with the category-specific location; and
displaying the geographical name with the corresponding category-specific geographic information.

2. The method of claim 1, wherein displaying the geographical name comprises one or more indications of distance between each category-specific location and location of the geographical name associated with the category-specific location.

3. The method of claim 1, wherein the particular category is tide, snow, or wildfire.

4. The method of claim 1, wherein the particular category of meteorological or terrain information is tide-related information.

5. The method of claim 1, wherein the category-specific geographic information comprises latitude and longitude coordinates.

6. The method of claim 1, further comprising:
receiving a selection of a geographical name for one of the corresponding category-specific locations; and
adding the selected geographical name to a list of category-specific locations.

7. A method comprising:
receiving a search request for information related to a particular category of meteorological or terrain information that is stored in a category-specific geographic database;
determining a first location based on the search request;
performing a category search of a geographical name database to identify one or more naming locations that are associated with the particular category of meteorological or terrain information and that are within a first specified distance of the first location;
for each of the one or more naming locations:
performing a spatial search of the category-specific geographic database to determine one or more category-specific locations within a second specified distance of the naming location;
retrieving category-specific geographic information corresponding to each naming location; and
displaying the naming location with the corresponding category-specific geographic information.

8. The method of claim 7, wherein the first location is a current location of the search request.

9. The method of claim 7, wherein the first location is a naming location associated with the received search request other than a current location of the search request.

10. The method of claim 7, wherein the category search comprises searching naming locations belonging to the particular category in the geographical name database.

11. The method of claim 10, wherein the particular category is tide.

12. The method of claim 7, wherein the displaying further comprising:
displaying the naming location on a map on a first part of a user interface (UI); and
displaying the particular category of meteorological or terrain information associated with the naming location on a second part of the UI.

13. The method of claim 7, further comprising:
receiving a selection of a geographical name for one of the corresponding category-specific locations; and
adding the selected geographical name to a list of category-specific locations.

14. A mobile device, comprising:
one or more processors; and
a memory coupled to the one or more processors, the memory storing instructions that cause the one or more processors to perform any one or more of operations comprising:
receiving a search request for information related to a particular category of meteorological or terrain information that is stored in a category-specific geographic database;
determining a current location of the search request;
performing a spatial search of the category-specific geographic database to determine one or more category-specific locations within a specified distance of the current location;
retrieve category-specific geographic information corresponding to the one or more category-specific locations having the particular category of meteorological or terrain information;
for each of the one or more category-specific locations:
performing a search of a geographical name database to identify a geographical name associated with the category-specific location; and
displaying the geographical name with the corresponding category-specific geographic information.

15. The mobile device of claim 14, wherein displaying the geographical name comprises one or more indications of distance between each category-specific location and location of the geographical name associated with the category-specific location.

16. The mobile device of claim 14, wherein the particular category of meteorological or terrain information is tide-related information.

17. A mobile device, comprising:
one or more processors; and
a memory coupled to the one or more processors, the memory storing instructions that cause the one or more processors to perform any one or more of operations comprising:
receiving a search request for information related to a particular category of meteorological or terrain information that is stored in a category-specific geographic database;
determining a first location based on the search request;
performing a category search of a geographical name database to identify one or more naming locations that are associated with the particular category of meteorological or terrain information and that are within a first specified distance of the first location;
for each of the one or more naming locations:
performing a spatial search of the category-specific geographic database to determine one or more category-specific locations within a second specified distance of the naming location;
retrieving category-specific geographic information corresponding to each naming location; and
displaying the naming location with the corresponding category-specific geographic information.

18. The mobile device of claim 17, wherein the first location is a current location of the search request.

19. The mobile device of claim 17, wherein the first location is a naming location associated with the received search request other than a current location of the search request.

20. The mobile device of claim 17, wherein the category search comprises searching naming locations belonging to the particular category in the geographical name database.
